(19) United States
(12) Patent Application Publication
(10) Pub. No.: US 2009/0166476 A1
(43) Pub. Date: Jul. 2, 2009

(54) Thruster system

(75) Inventor: James A Termini, Dickinson, TX (US)

Correspondence Address: FISH & RICHARDSON P.C., P.O BOX 1022, Minneapolis, MN, 55440-1022, US

(73) Assignee: SPACEHAB, Inc., Houston, TX (US)

(21) Appl. No.: 12/331,183

(22) Filed: Dec. 9, 2008

Related U.S. Application Data
(60) Provisional application No. 61/012,602, filed on Dec. 10, 2007.

(51) Int. Cl. B64G 1/26

(52) U.S. Cl. 244/158.6

(57) ABSTRACT

Enhanced translational thrusting is provided by reaction engines configured to permit translational thrusting off or through the center of gravity of a spacecraft or other vehicle. Among other applications, this approach is useful for a Satellite Life Extension System (SLES) that provides maintenance services to orbiting satellites. By attaching to the satellite and conducting maneuvers to maintain its operational orbit and attitude, the SLES increases the working lifetime of the satellite. Since the engines of the SLES are redundant, the failure of a single engine will not jeopardize the overall success of the mission.

This application claims priority to U.S. Provisional Application Ser. No. 61/012,602.

### TECHNICAL FIELD

The present disclosure generally relates to translational and rotational thrusting of reaction engines.

### BACKGROUND INFORMATION

The functional lifespan of a geosynchronous satellite is typically limited by the onboard fuel supply used to maintain its orbit and attitude. Aside from this limitation, the electronics and mechanical systems of conventional satellites are generally designed to provide many additional years of service.

### SUMMARY

According to one general implementation, enhanced translational thrusting is provided by the reaction engines. In particular, a reaction engine is configured to permit translational thrusting off or through the center of gravity of a spacecraft or other vehicle.

Among other applications, this approach is useful for a Satellite Life Extension System (SLES) that provides maintenance services to orbiting satellites. By attaching to the satellite and conducting maneuvers to maintain its operational orbit and attitude, the SLES increases the working lifetime of the satellite. Since the engines of the SLES are redundant, the failure of a single engine will not jeopardize the overall success of the mission.

According to another general implementation, a thruster system includes a first body attached to a second body, translational thrusters attached to the first body, and rotational thrusters attached to the first body. The translational thrusters generate a translational force that if not directed through the center of gravity will produce a moment that can be nulled by the rotational thrusters.

The details of one or more implementations are set forth in the accompanying drawings and the description below. Other potential features and advantages of the disclosure will be apparent from the description and the drawings.

### BRIEF DESCRIPTION OF THE DRAWINGS

FIGS. 1 to 6 depict various configurations of thruster systems.

In FIGS. 2 to 6 like reference numbers represent corresponding parts throughout.

### DETAILED DESCRIPTION

According to one general implementation, enhanced translational thrusting is provided by the reaction engines. In particular, as depicted in FIGS. 2 to 6, a reaction engine is configured to permit translational thrusting off or through the center of gravity of a spacecraft or other vehicle, such as a submarine, a dirigible, a hovercraft, a boat, and/or the like.

Among other applications, this approach is useful for a Satellite Life Extension System (SLES) that provides maintenance services to orbiting satellites. By attaching to the satellite and conducting maneuvers to maintain its operational orbit and attitude, the SLES increases the working lifetime of the satellite. Since the engines of the SLES are redundant, the failure of a single engine will not jeopardize the overall success of the mission.

U.S. Pat. Nos. 5,806,802, 6,017,000, 6,330,987, 6,484,973, and U.S. Published Patent Application No. 2005258311A1 describe a teleoperated SLES, which is essentially the Russian Progress spacecraft and Teleoperatorniy Rezhim Upravleniya or TORU system, which was included in the core Mir module launched on Feb. 20, 1986. The Progress/TORU system may predate these patents by at least ten years.

U.S. Published Patent Application No. 2004026571A1 describes a system of a “Mother-ship” and “Mini Satellite Inspection, Recovery and Extension” spacecraft, where a primary satellite is launched with a secondary inspection satellite and, after release of the combined satellites into orbit, the secondary inspection satellite is released to inspect the primary satellite. The system described in this patent application may have been demonstrated with the SNAP-1 satellite launched on Jun. 28, 2000 that may predate this patent application by more than two years. This SNAP-1 satellite was a 3-axis butane propellant stabilized satellite that weighed 6.5 kg. This spacecraft obtained the first in-orbit pictures of another spacecraft from a satellite as it took pictures of the Russian Nadezhda satellite, as well as Tsinghua-1, in orbit shortly after deployment from the Cosmos 3-M launcher.

The aforementioned patents and patent applications fail to disclose a practical propulsion system to enable a life extension spacecraft to efficiently perform full X, Y and Z axis translational maneuvers while two spacecraft are attached to each other. Such maneuvers are critical when performing a SLES mission, especially in a case of a geostationary satellite where full N/S and E/W translational station keeping maneuvers are critical.

U.S. Pat. No. 6,945,500 discloses a SLES configuration that hosts three engine pods, one containing a single engine, designated the primary engine, and the other two each containing five engines, for a total of eleven engines. The single engine pod boom extends in the positive radial direction (i.e., away from the earth) so that its thrust force will be directed in the negative radial direction, or towards the earth. The other engine pod booms generally are orthogonal to the orbit plane, extending in north and south directions, relative to the earth. As pointed out in U.S. Pat. No. 6,945,500, this system provides redundancy, but a close examination of that redundancy reveals several limitations, as will be further described.

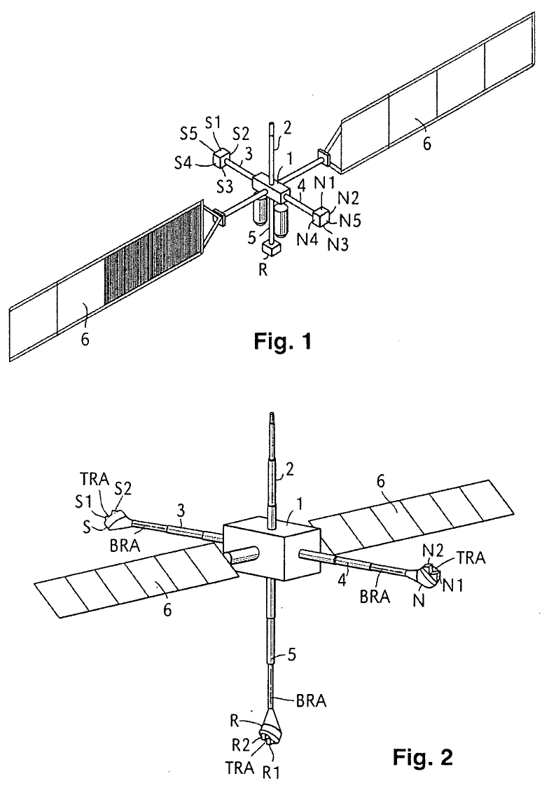

FIG. 1 illustrates an exemplary SLES in a Local Vertical Local Horizontal (LVLH) coordinate system. In this system, X is tangential to the orbit and points in the direction of motion (i.e., the velocity vector), Z points to the earth's center, and Y completes the right-handed triad (i.e., south). The primary engine designated R (radial) provides a thrust force in the +Z direction. Pods N (north) and S (south) contain engines N1 through N5 and S1 through S5, respectively.

The design shown in FIG. 1 reveals several limitations with regard to thruster redundancy. Consider that R is redundant with engines N3 and S3. If engine N3 or engine S3 fails, engine R alone would be one candidate for radial thrusting, to effectuate East-West adjustments. The use of either N3 or S3 will introduce a roll rate that is difficult to remove except by using momentum wheels.

Engine N3 is redundant with engine S1, but the failure of either precludes coupling forces to remove positive roll rates via the use of momentum wheels. Engine N1 is redundant with engine S3, but the failure of either precludes coupling forces to remove negative roll rates via the use of momentum wheels. Engine N4 is redundant with engine S2, but the failure of either engine precludes coupling forces to remove negative yaw rates via the use of momentum wheels. Engine N2 is redundant with engine S4, but the failure of either engine precludes coupling forces to remove positive yaw rates via the use of momentum wheels.

For removal of pitch rates, engine N2 is redundant with engine S2, and engine N4 is redundant with engine S4. A failure of engines N7 or S2 precludes coupling forces to remove negative pitch rates, and a failure of engines N4 or S4 precludes coupling forces to remove positive pitch rates. Engines N5 and S5 have no redundancy. If either engine fails, South and North adjustments, respectively, will be precluded.

Using the enhanced approach described herein, induced moments created by applying translational thrust forces to a composite (e.g., Satellite Life Extension Spacecraft/host satellite) spacecraft may be efficiently cancelled without applying translational thrust forces directly through the composite satellite's center of gravity. This approach offers a high level of operational redundancy while minimizing the number of thrusters used to obtain redundancy. Furthermore, plume impingement on the host satellite by the SLES spacecraft is reduced.

Unlike other propulsion systems, this approach provides a practical propulsion system that enables a life extension spacecraft to efficiently perform full X, Y and Z axis translational maneuvers while two spacecraft are attached to each other. Such maneuvers may be used when performing a SLES mission, especially in the case of a geostationary satellite where full North-South and East-West translational station-keeping maneuvers are frequently used. Furthermore, the enhanced approach does not suffer from the redundancy limitations provided by conventional systems.

Taking thrust deflections into account, Hall thrusters have the capability to gimbal ±36.5°. (A gimbal is a platform that can pivot, which means that instead of being fixed to an unmoving base, an object on a gimbal can rotate along at least one axis (e.g., roll, pitch and yaw).) Additionally, the thrust vector can be varied by up to 2° by altering the thruster's magnetic field. These features can be used in attempting to counter the rates described above.

In one example, consider a scenario where either engines N4 or S2 fail. Opposing deflection angles of up to 38.5° applied to engines N5 and S5 can create coupling forces in the effort to compensate for the failed coupling of the engines N4 and S2. The coupling thrust forces are determined by the sine of the deflection angle, which may reduce efficiency to 62%. Fuel may then be wasted since the cosine components of the thrust forces are directly opposed. Moreover, there is actually another loss in efficiency that must be taken into account, namely, a weakening of the thrust forces in consequence of altering the magnetic field to achieve deflections.

Irrespective of the capability to gimbal each engine, not all points between engine pods will be accessible by the thrust vector. Such gaps preclude thrusting through the center of gravity (e.g.) if the e.g. happens to lie within this region. This reduction of access can be perceived by considering any two engines on adjacent sides of the same pod. Cones formed by thrust vectors resulting from gimbaling up to ±38.5° will not intersect, as would be the case if gimbaling of at least ±45° were feasible. For cases in which the e.g. is not located in the inaccessible region, there may still be a need to conduct a dual task thrust through a point in the region to correct in the most efficient manner both angular and translational motions simultaneously.

Accordingly, an enhanced approach described herein provides effective designs for an efficient propulsion of a SLES spacecraft that enables a life extension spacecraft to efficiently perform full X, Y and Z axis translational maneuvers while a SLES and primary spacecraft are attached to each other and provide adequate operational redundancy. Such maneuvers are particularly useful when performing a SLES mission, especially in the case of a geostationary satellite where full North-South and East-West translational station keeping maneuvers are implemented.

FIGS. 2 to 5 display exemplary thruster system designs, which will be described with respect to implementation on a satellite system, but are not limited to use on a spacecraft, but may be used on any object requiring maneuvering in a volume In each design, the spacecraft body 1 includes the electronics modules used to operate the system. Propellant tanks can be internal or external to the spacecraft body 1. The capture device (or host satellite attachment mechanism) 2 uses a mechanism to attach to a host spacecraft.

The spacecraft body 1 includes six engines, labeled S1, S2, N1, N2, R1, and R2, placed at the ends of booms. These booms are on three turret pods (design 1) or three rotor pods (design 2), designated S, N, and R, generally aligned with the south, north, and negative radial directions relative to the earth, respectively. FIGS. 2 and 4 display the pods extended on south telescoping boom 3, north telescoping boom 4, and radial telescoping boom 5. The thrust vectors of engines S1, N1, and R1 are coincident with their respective boom axes, and the thrust vectors of engines S2, N2 and R2 are orthogonal to the boom axes. There are two engines per pod. Solar arrays 6 also extend from the spacecraft body 1.

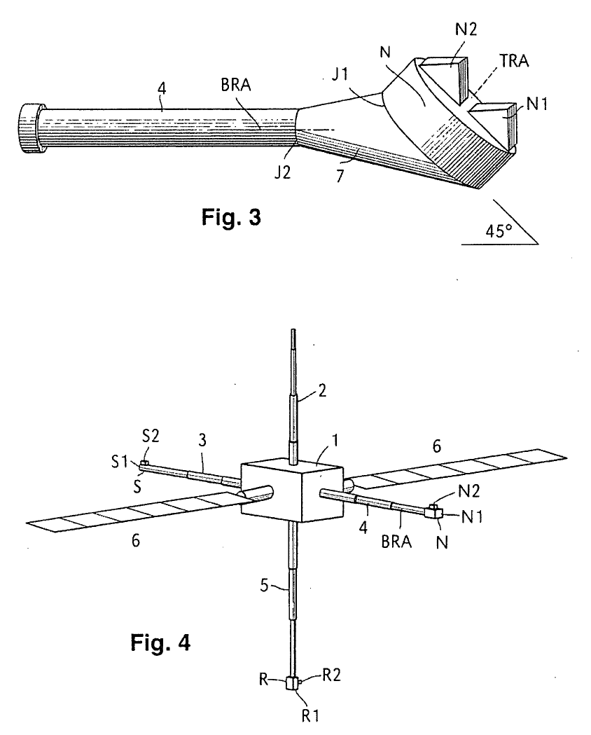

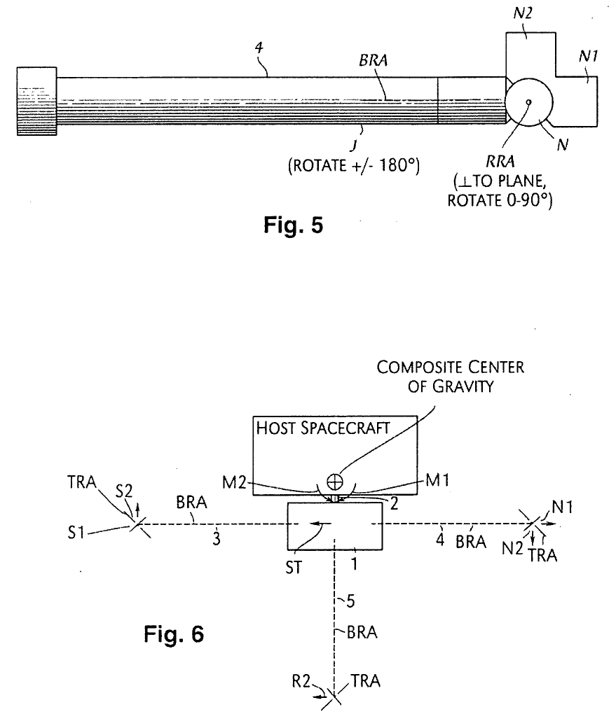

As shown in FIG. 3 each turret rotation axis (TRA) is positioned at 45° relative to its boom axis and is capable of at least ±180° rotations relative to the turret flange 7 about the turret joint J1. Additionally, each boom includes a flange joint J2 that is capable of at least ±180° degree rotations about the boom rotation axis (BRA). Accordingly, the previously described location gaps that could not be accessed by the thrust vector are eliminated. This outcome applies as well to the rotor design shown in FIG. 5. The rotor can rotate up to 90° about the rotor rotation axis (RRA), and as described above, the boom can rotate at least ±180° about the BRA, thereby eliminating the location gaps.

The engines on both the turret pod and the rotor pod designs are redundant to each other. If an engine fails on a turret pod, then the other engine can be rotated 180° by the turret to the failed engine's position as needed, and can then be rotated back to its original position to continue carrying out tasks from that location as well. If an engine fails on the rotor pad it can be replaced by the other engine by a 90° rotation of the rotor and, if necessary, by a 180° rotation of the boom. Only one engine per turret pod or rotor pod is required to carry out all the functions of this SLES system, although the second engine can be included on a pod for redundancy.

FIG. 6 illustrates operation of an exemplary SLES spacecraft thruster system, according to another general implementation. In this example, the turret design is referenced, but it is recognized that the rotor design can produce the same results. A southward thrust ST is requested. Engine N1 applies a thrust to accomplish the desired southward thrust ST but also induces a translation thrust induced moment M1. The moment M1 is cancelled by intentional moment M2 created by thrusting with engines N2 and S2. By thrusting with engines N2 and S2, the net moment created does not induce a net translational force. Thus, the net effect is to generate a translational motion in the ST direction. To illustrate the inherent redundancy in the system, engine S1 could be used in place of a failed engine S2 if the South thruster assembly turret is rotated 180 degrees to place the engine S1 in the engine S2 position, and vice versa.

As also illustrated in FIG. 6, an alternate process for generating a restoring moment is to fire the engine R2 in the opposite direction of the engine N1. Since the engine R2 has a larger moment arm than the engine N1, a smaller thrust will generate an equivalent moment but produce a net translational force in the ST direction. This process could be used for redundancy in the event of a failure of engines N2 or S2.

North-South translational maneuvers are accomplished via thrusters on the north boom 4 and south boom 3. Assuming the combined satellite pair is orbiting in an easterly direction, eastward translation maneuvers are accomplished by firing either of the radial boom 5 thrusters in the zenith direction (i.e., away from the earth) to lower the orbit altitude and “speed up” the orbital velocity thus moving the satellite in an eastward direction relative to the surface of the earth. For a westward translation maneuver, both S1 or S2 and NJ or N2 thrusters would fire in the nadir (towards the earth) direction. Both thrusters would fire simultaneously to cancel any induced moments. This would raise the orbit altitude and “slow down” the orbital velocity thus moving the satellite in a westward direction relative to the surface of the earth.

A number of implementations have been described. Nevertheless, it will be understood that various modifications may be made without departing from the spirit and scope of the disclosure. Accordingly, other implementations are within the scope of the following claims.

What is claimed is:

1. A thruster system comprising:
a first body attached to a second body;
a translational thruster attached to the first body; and
a set of rotational thrusters attached to the first body, wherein the translational thruster generates a translational force and moment and the set of rotational thrusters null the moment.

2. A method of thrusting comprising:
a translational thruster applying a translational force and a first moment to a first body attached to a second body; and
a set of rotational thrusters applying a second moment to the first body attached to the second body, wherein said second moment cancels said first moment.
